(19) United States
(12) Patent Application Publication
(10) Pub. No.: US 2022/0289032 A1
(43) Pub. Date: Sep. 15, 2022

(54) A BATTERY JUNCTION BOX AND A BATTERY PACK FOR A VEHICLE

(71) Applicant: Scania CV AB, Södertälje (SE)

(72) Inventors: Georgios PAPADOPOULOS, Edessa (GR); Carl TENGSTEDT, Grödinge (SE); Jens GUSTAVSSON, Strängnäs (SE); Christer ROOS, Rönninge (SE); Hans-Peter NEE, Bro (SE)

(73) Assignee: Scania CV AB, Södertälje (SE)

(21) Appl. No.: 17/638,954

(22) PCT Filed: Sep. 3, 2020
(86) PCT No.: PCT/SE2020/050832

§ 371 Date: Feb. 28, 2022

(30) Foreign Application Priority Data
Sep. 5, 2019 (SE) 1951010-6

(51) Int. Cl. B60L 3/00; B60L 50/64; H02H 3/087

(52) U.S. Cl. CPC B60L 3/0046; B60L 50/64; H02H 3/087; B60L 2200/36

(57) ABSTRACT

A battery junction box, comprising: a first input connected to a first output via a switch circuit, which switch circuit is configured to connect the first input to the first output upon receiving a control signal from a controller; the battery junction box further comprises a second input connected to a second output, via a fuse and a main switch arranged in series. The switch circuit further comprises at least a first branch with a semiconductor switch between the first input and the first output, which semiconductor switch has a control line connected to the controller; and the switch circuit further comprises a second branch with a snubber circuit, which second branch is parallel with the first branch between the first input and the first output; and a flywheel diode with a first terminal connected to the first output, and a second terminal connected to the second output.

### CROSS-REFERENCE TO RELATED APPLICATIONS

This application is a National Stage Patent Application (filed under 35 § U.S.C. 371) of PCT/SE2020/050832, filed Sep. 3, 2020 of the same title, which, in turn claims priority to Swedish Patent Application No. 1951010-6 filed Sep. 5, 2019 of the same title; the contents of each of which are hereby incorporated by reference.

### FIELD OF THE INVENTION

The present invention relates to a battery junction box comprising a first input connected to a first output via a switch circuit, which switch circuit is configured to connect the first input to the first output upon receiving a control signal from a controller, the battery junction box further comprises a second input connected to a second output, via a fuse and a main switch arranged in series. The invention also relates to a battery pack comprising such a battery junction box, and an electric vehicle provided with such a battery pack. The electric vehicle typically comprises an electric motor for the propulsion of the vehicle.

### BACKGROUND OF THE INVENTION

A battery junction box is used to control the connection between a battery pack and a DC link of an electric vehicle. This means that the battery junction box must be able to switch high voltage and high current. In conventional battery junction boxes at least two mechanical switches are used together with a fuse and a flywheel diode.

The DC link often exhibit both capacitance and inductance from the wiring harness of the vehicle. These reactive components often cause problems during switch-on and switch-off of the battery pack by means of the battery junction box. An inductive component may cause arcing in the mechanical switches during switch-off. A capacitive component may cause a large inrush of current during switch-on. A common solution to mitigate the effect of inductive components is to provide a flywheel diode.

The problem of large inrush current during switch-on is often mitigated by a controlled pre-charge of the capacitances in the wiring harness. This is handled by a pre-charge branch which employs a switch in series with a resistor, the resistor limits the inrush current during switch-on. This precharge branch is arranged in parallel with a main switch. The switch-on is performed by first activating the pre-charge branch and charge the capacitance through the resistor, followed by activation of the main switch.

The conventional battery junction box may also employ a current sensor in form of a shunt resistor with a voltmeter, either on the high side or on the low side. In order to provide increased safety of an electrical vehicle there is an interest in replacing the mechanical switches with electronic switches, with for example MOSFET devices. However, the switching of high voltage and high current is associated with a number of problems with conventional silicone-based MOSFET devices. But the availability of widebandgap devices such as MOSFET devices based on gallium nitride or silicon carbide provides new solutions.

However, the flywheel diode does usually not provide enough protection for overvoltage and arcing, and therefore other solutions are currently investigated.

It is thus an object of the present invention to provide a battery junction box that enables switching of high voltages and high currents with an electronic switch.

A further object of the invention is to provide a battery junction box with a reduced number of components, that simultaneously allows charging of the battery pack through the battery junction box.

### SUMMARY OF THE INVENTION

The object of the invention is achieved by means of the initially defined battery junction box, said battery junction box being characterized in that the switch circuit comprises at least a first branch with a semiconductor switch between the first input and the first output, which semiconductor switch has a control line connected to the controller, and the switch circuit further comprises a second branch with a snubber circuit, which second branch is parallel with the first branch between the first input and the first output, and a flywheel diode with a first terminal connected to the first output, and a second terminal connected to the second output.

This provides an advantageous solution to the above problems and furthermore provides a battery junction box with increased safety and protection during high voltage and high current switching.

According to one embodiment, the snubber circuit of the second branch comprises a capacitor in series with a diode, and in that a resistor is arranged in paralell with the diode. This snubber circuit provides increased protection for the switch circuit.

According to one embodiment, the semiconductor switch is a transistor.

According to one embodiment, the transistor is made of a wide bandgap material. This allows switching with high electrical fields and high temperature.

According to one embodiment, the wide bandgap material is SiC (silicon carbide), or GaN (gallium nitride).

According to one embodiment, the transistor is a MOSFET (metaloxide semiconductor field effect transistor). This allows charging in the reverse direction of the transistor due to the body diode of the MOSFET that is forward biased in the reverse direction.

The object of the invention is also achieved by means of the battery pack with at least one battery module and characterized in that it comprises a battery junction box according to the present invention wherein the first input and the second input of the battery junction box is connected to the at least one battery module, and wherein the first output and the second output of the battery junction box is configured to be connected to the load.

Further features and advantages of the invention would be presented in the following detailed description of embodiments.

### BRIEF DESCRIPTION OF THE DRAWINGS

FIG. 1 is a schematic circuit drawing of a battery junction box according to an embodiment,

FIG. 2 is a schematic block drawing of the battery pack according to an embodiment, and

FIG. 3 is a schematic drawing of a vehicle with a battery pack according to an embodiment.

### DETAILED DESCRIPTION

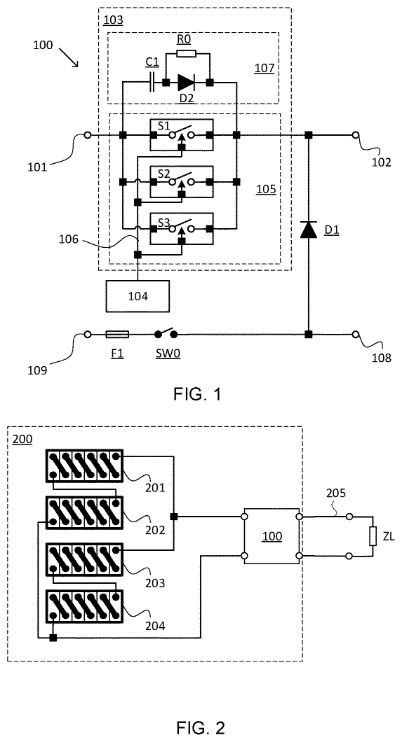

FIG. 1 shows a schematic circuit drawing of a battery junction box, generally designated 100, according to an embodiment. The battery junction box comprises a first input 101 connected to a first output 102 via a switch circuit 103. The switch circuit is configured to connect the first input to the first output upon receiving a control signal from a controller 104. The battery junction box further comprises a second input 109 connected to a second output 108, via a fuse (F1) and a main switch (SW0) arranged in series. The control signal may be an electric pulse or a voltage level that indicates the desired state of the switch circuit 103, for example 0 V for “OFF”-state and 5 V for “ON”-state.

The switch circuit 103 comprises at least a first branch 105 with a semiconductor switch S1-S3 between the first input and the first output, which semiconductor switch has a control line 106 connected to the controller.

The switch circuit further comprises a second branch 107 with a snubber circuit, which second branch is parallel with the first branch between the first input and the first output. A flywheel diode D1 with a first terminal connected to the first output, and a second terminal connected to the second output is also provided.

The snubber circuit of the second branch 107 comprises a capacitor C1 in series with a diode D2, and a resistor R0is arranged in paralell with the diode D2. Other configurations of snubber circuits comprising these elements are of course possible.

The snubber circuit and the flywheel diode provides safety measures against overvoltages due to switching of inductive loads, which may cause severe overvoltages over the switch without these safety measures. These severe overvoltages may easily destroy the semiconductor switch.

The semiconductor switches of FIG. 1 are preferably transistors of MOSFET (metaloxide semiconductor field effect transistor) type. Since these transistors provide low switch losses and low resistance in the on-state they are preferred. Furthermore, if increasead maximum electrical field and increased temperature for operation are of interest MOSFET devices of wide bandgap materials such as SiC (silicon carbide), or GaN (gallium nitride) may be preferred.

Another beneficial feature of the battery junction box according to the present invention is that if a MOSFET is used for switches (S1-S3), charging in the reverse direction is possible due to the body diode in the MOSFET. However, in order to interrupt charging the main switch SW0 may be used, since the controller 104 is not controlling the MOSFET in the reverse direction. This means that the switches S1-S3 may be used for disconnection due to short-circuits on the output side of the battery junction box, and interrupt of charging may be performed by means of the main switch SW0.

Other types of transistors may also be employed such as for example IGBT devices, the selection of transistor type is to a large degree dependent on the voltage of the DC link as well as supplied current. By arranging semiconductor switches in parallel as showed in FIG. 1 the current drive performance may be scaled. Furthemore, each semiconductor switch may be provided a dedicated drive circuit as well as a snubber circuit.

Additionally, in FIG. 1 the controller 104 is shared by all switches S1-S3. However, each switch S1 to S3 may be provided with a dedicated controller 104 in other embodiments.

Now with reference made to FIG. 2 a battery pack, generally designated 200, is schematically illustrated. The battery pack is provided for supplying a load (ZL) with electric power via a so called DC link 205. The battery pack comprises at least one battery module 201-204), The battery pack comprises a battery junction box 100 according to the present invention, wherein the first input and the second input of the battery junction box is connected to the at least one battery module, and wherein the first output and the second output of the battery junction box is configured to be connected to the load (ZL). The load may comprise an inverter and an electrical motor connected to the DC link.

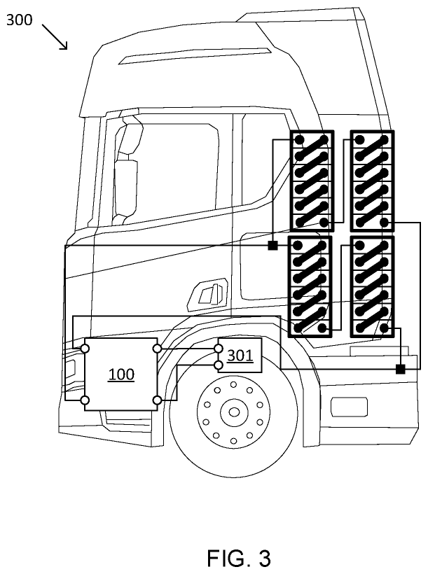

FIG. 3 shows schematically a vehicle, generally designated 300, The vehicle comprises a battery pack according to the present invention with a battery junction box 100 that is connected to an inverter 301 for supplying electric power to an electrical motor of the vehicle, which electrical motor and inverter constitutes the load. The electric motor may be provided for propulsion of the vehicle, and the inverter 301 is connected to the first output and the second output of the battery junction box of the battery pack. Furthermore, the vehicle may comprise a plurality of battery packs according to the present invention connected to the DC link of the vehicle, and each of the battery packs is provided a battery junction box according to the present invention. This allows remote control of connection of each battery pack to the DC link, which may be useful if for example one battery module is failing.

The battery junction box and the battery pack of the invention provides a number of advantageous features, for example by employing semiconductor switches a battery management system (BMS) may be configured to disconnect the batterys upon detection of anomalies. This solution provides additional safety to the battery pack of the vehicle, such as for example disconnection of the battery module to the DC link by means of the battery junction box upon collision detection.

1. A battery junction box comprising:
a first input connected to a first output via a switch circuit, which switch circuit is configured to connect the first input to the first output upon receiving a control signal from a controller;
a second input connected to a second output, via a fuse and a main switch arranged in series; and
a flywheel diode with a first terminal connected to the first output, and a second terminal connected to the second output,
wherein the switch circuit comprises:
at least a first branch with a semiconductor switch between the first input and the first output, which semiconductor switch has a control line connected to the controller; and
a second branch with a snubber circuit, which second branch is parallel with the first branch between the first input and the first output.

2. A battery junction box according to claim 1, wherein the snubber circuit of the second branch comprises a capacitor in series with a diode, and wherein a resistor is arranged in parallel with the diode.

3. A battery junction box according to claim 1, wherein the semiconductor switch is a transistor.

4. A battery junction box according to claim 3, wherein the transistor is made of a wide bandgap material.

5. A battery junction box according to claim 4, wherein the wide bandgap material is one of SiC (silicon carbide) or GaN (gallium nitride).

6. A battery junction box according to claim 3, wherein the transistor is a MOSFET (metaloxide semiconductor field effect transistor).

7. A battery pack for supplying a load with electric power, wherein the battery pack comprises:
at least one battery module; and
a battery junction box comprising:
a first input connected to a first output via a switch circuit, which switch circuit is configured to connect the first input to the first output upon receiving a control signal from a controller:
a second input connected to a second output, via a fuse and a main switch arranged in series; and
a flywheel diode with a first terminal connected to the first output, and a second terminal connected to the second output,
wherein the switch circuit comprises:
at least a first branch with a semiconductor switch between the first input and the first output, which semiconductor switch has a control line connected to the controller; and
a second branch with a snubber circuit, which second branch is parallel with the first branch between the first input and the first output,
wherein the first input and the second input of the battery junction box is connected to the at least one battery module, and
wherein the first output and the second output of the battery junction box is configured to be connected to the load.

8. A vehicle comprising an electric motor, and a battery pack according to claim 7, wherein the load comprises the electric motor for propulsion of the vehicle, and the electric motor is connected to the first output and the second output of the battery junction box of the battery pack via an inverter.
